(19) United States
(12) Patent Application Publication
(10) Pub. No.: US 2025/0191424 A1
(43) Pub. Date: Jun. 12, 2025

(54) Autonomous Driving Control Apparatus And Method Thereof

(71) Applicants: Hyundai Motor Company, Seoul (KR); Kia Corporation, Seoul (KR); HYUNDAI AUTOEVER Corp., Seoul (KR)

(72) Inventors: Yu Ho Choi, Seoul (KR); Kyeng Taek Kim, Anyang-si, Gyeonggi-Do (KR)

(21) Appl. No.: 18/668,857

(22) Filed: May 20, 2024

(30) Foreign Application Priority Data
Dec. 7, 2023 (KR) 10-2023-0177099

(51) Int. Cl. G07C 5/08; B60W 60/00

(52) U.S. Cl. CPC G07C 5/085; B60W 60/00

(57) ABSTRACT

An autonomous driving control apparatus is configured to collect, during an operation of autonomous driving of a vehicle, pieces of data about autonomous driving control of the vehicle, store, in at least one buffer of a first memory of a first type, the pieces of data about autonomous driving control of the vehicle, wherein the pieces of data about autonomous driving control of the vehicle is configured to be stored in a first format, convert at least a portion of the pieces of data about autonomous driving control of the vehicle to a second format for storing in a storage of a second type, receive a triggering signal, and based on a reception time of the triggering signal, store, in the storage of the second type, driving data corresponding to a specified duration, wherein the specified duration is determined based on the reception time of the triggering signal.

### CROSS-REFERENCE TO RELATED APPLICATION

This application claims the benefit of priority to Korean Patent Application No. 10-2023-0177099, filed in the Korean Intellectual Property Office on Dec. 7, 2023, the entire contents of which are incorporated herein by reference.

### TECHNICAL FIELD

The present disclosure relates to an autonomous driving control apparatus and a method thereof, and more particularly, relates to technologies for efficiently storing pieces of data identified while a host vehicle is traveling.

### BACKGROUND

As autonomous vehicles have been gradually spread, various technologies about autonomous driving have been developed. For example, there may be a need for more and more data for stable driving of the autonomous vehicle. Thus, a technology for efficiently storing and managing data should be developed.

### SUMMARY

The following summary presents a simplified summary of certain features. The summary is not an extensive overview and is not intended to identify key or critical elements.

An aspect of the present disclosure provides an autonomous driving control apparatus for adaptively performing an operation of storing and managing data although there is a limitation to the number (or capacity) of buffers included in a memory when a trigger signal about storing data is continuously generated, in the process of storing data about the driving of a host vehicle in the memory.

Another aspect of the present disclosure provides an autonomous driving control apparatus for sequentially storing pieces of data in a memory with regard to priorities for the pieces of data when storing the pieces of data.

Another aspect of the present disclosure provides an autonomous driving control apparatus for identifying a time point when a trigger signal is generated and storing data during a specified duration including a specified time (e.g., 30 seconds) before the identified time point and a specified time (e.g., 30 seconds) after the identified time point in a memory to efficiently store data at the same as complying with laws and regulations.

Another aspect of the present disclosure provides an autonomous driving control apparatus for temporarily storing a node provided by dividing data by a unit time in a buffer (e.g., a buffer in a RAM or other first types of memories accessible by one or more processors for faster processing) and quickly identifying at least one node which should be stored in a storage device (e.g., an embedded multi-media Card (eMMC), a solid state drive (SSD), or other second types of storage devices, which may provide slower processing than the first types of memories) based on time information included in the node to store pieces of driving data included in the identified at least one node in the storage device. For example, another aspect of the present disclosure provides an autonomous driving control apparatus for storing a file including pieces of driving data in the storage device and setting time information corresponding to the identified at least one node to a file name of the file to quickly and accurately identify time information of the pieces of driving data later.

Another aspect of the present disclosure provides an autonomous driving control apparatus for quickly copying at least some data associated with a triggering signal (hereinafter, it may be referred to as a trigger signal) among the pieces of data temporarily stored in a buffer to a storage device (e.g., an embedded multi-media card (eMMC), a solid state drive (SSD), etc.).

In at least some driving areas, according to the laws and regulations, an autonomous driving control apparatus may need to store at least some of pieces of data generated (or identified) while performing autonomous driving control for a host vehicle in its memory.

However, as an autonomous driving technology is developed, sizes of pieces of data to be stored by the autonomous driving control apparatus and a time when the pieces of data are stored are increasing more and more. In addition, when a certain situation, such as a situation in which pieces of data should be consecutively stored or a situation in which the autonomous driving control apparatus is rest, occurs, there is a need for a method for efficiently storing and managing driving data in the autonomous driving control apparatus.

The technical problems to be solved by the present disclosure are not limited to the aforementioned problems, and any other technical problems not mentioned herein will be clearly understood from the following description by those skilled in the art to which the present disclosure pertains.

An autonomous driving control apparatus may comprise: memory storing at least one instruction; and a controller operatively coupled to the memory, wherein the at least one instruction is configured to, when executed by the controller, cause the autonomous driving control apparatus to: collect, during an operation of autonomous driving of a vehicle, pieces of data about autonomous driving control of the vehicle; store, in at least one buffer of a first memory of a first type, the pieces of data about autonomous driving control of the vehicle, wherein the pieces of data about autonomous driving control of the vehicle is configured to be stored in a first format; convert at least a portion of the pieces of data about autonomous driving control of the vehicle to a second format for storing in a storage of a second type; receive a triggering signal; and based on a reception time of the triggering signal, store, in the storage of the second type, driving data corresponding to a specified duration, wherein the specified duration is determined based on the reception time of the triggering signal, and wherein the driving data corresponding to the specified duration is converted, from the first format to the second format, based on a portion of the pieces of data about autonomous driving control of the vehicle.

The at least one instruction may be configured to, when executed by the controller, cause the autonomous driving control apparatus to: store the pieces of data about autonomous driving control of the vehicle by storing a first portion of the pieces of collected data in a first buffer of the at least one buffer, while performing the autonomous driving control in a specified driving section for the vehicle, wherein the first portion of the pieces of collected data is associated with the reception time of the triggering signal.

The at least one instruction may be configured to, when executed by the controller, cause the autonomous driving control apparatus to: store the pieces of data about autonomous driving control of the vehicle by storing a second portion of the pieces of collected data in the first buffer, wherein the second portion of the pieces of collected data is associated with a reception time of a second triggering signal, wherein the second portion of the pieces of collected data is stored, using a pointer associated with the reception time of the second triggering signal, in the first buffer, and wherein the first portion of the pieces of collected data is stored, using a pointer associated with the reception time of the triggering signal, in the first buffer.

The storage of the second type may comprise at least one of: an embedded multi-media card (eMMC); or a solid state drive (SSD).

The at least one instruction may be configured to, when executed by the controller, cause the autonomous driving control apparatus to: store specified data corresponding to a predefined event among the pieces of data, in the storage of the second type, based on a determination that the predefined event occurs while collecting the pieces of data.

The at least one instruction may be configured to, when executed by the controller, cause the autonomous driving control apparatus to: store, in the at least one buffer, first driving data corresponding to a first duration associated with the reception time of the triggering signal; store, in the at least one buffer, second driving data corresponding to a second duration associated with a second reception time of a second triggering signal, the second reception time being subsequent to the reception time; and store, in the storage of the second type, the first driving data and the second driving data respectively corresponding to the first duration and the second duration among the pieces of data stored in the at least one buffer.

The at least one instruction may be configured to, when executed by the controller, cause the autonomous driving control apparatus to: divide the pieces of collected data into at least one node and store the at least one node in the at least one buffer; and store at least one piece of the driving data in which first time information of a first node corresponding to the specified duration among the at least one node is set to a file name in the storage of the second type, and wherein the at least one node comprises at least one of time information, data collected in response to the time information, identification information of a next node, or identification information of a previous node, or any combination thereof.

The at least one instruction may be configured to, when executed by the controller, cause the autonomous driving control apparatus to: store, in the at least one buffer, at least one random access memory (RAM) file system respectively corresponding to the at least one node; and copy a specified RAM file system corresponding to the specified duration among the at least one RAM file system to the storage of the second type, based on the triggering signal, and wherein the at least one RAM file system comprises at least one of the time information of the at least one node or the data collected in response to the time information, or any combination thereof.

The predefined event comprises at least one of: activation or deactivation of at least a part of an autonomous driving system of the vehicle that comprises the autonomous driving control apparatus; occurrence of an event of at least one of a transition demand (TD), a minimum risk maneuver (MRM), or an emergency maneuver (EM), or any combination thereof; an update of data of an event data recorder (EDR); occurrence of deterioration in performance of the vehicle or occurrence of a failure in the vehicle; or any combination thereof.

The at least one instruction may be configured to, when executed by the controller, cause the autonomous driving control apparatus to: encrypt and store at least one of position information of the vehicle among the driving data or user information, or any combination thereof.

An autonomous driving control method may comprise: collecting, by a controller and during an operation of autonomous driving of a vehicle, pieces of data about autonomous driving control of the vehicle; storing, in at least one buffer of a first memory of a first type, the pieces of data about autonomous driving control of the vehicle, wherein the pieces of data about autonomous driving control of the vehicle is configured to be stored in a first format; converting, by the controller, at least a portion of the pieces of data about autonomous driving control of the vehicle to a second format for storing in a storage of a second type; receiving, by the controller, a triggering signal; and based on a reception time of the triggering signal, storing, by the controller and in the storage of the second type, driving data corresponding to a specified duration, wherein the specified duration is determined based on the reception time of the triggering signal, and wherein the driving data corresponding to the specified duration is converted, from the first format to the second format, based on a portion of the pieces of data about autonomous driving control of the vehicle.

The autonomous driving control method may perform one or more operations described herein and/or implement one or more features implemented herein.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating components of an autonomous driving control apparatus according to an example of the present disclosure;

FIG. 2 is a conceptual diagram illustrating components and an operation of an autonomous driving control apparatus according to an example of the present disclosure;

FIG. 3A is a conceptual diagram illustrating data stored by an autonomous driving control apparatus according to an example of the present disclosure;

FIG. 3B is a conceptual diagram illustrating data stored by an autonomous driving control apparatus according to an example of the present disclosure;

FIG. 4 is an operational conceptual diagram of an autonomous driving control method according to an example of the present disclosure;

FIG. 5 is an operational conceptual diagram of an autonomous driving control method according to an example of the present disclosure;

FIG. 6 is a flowchart of an autonomous driving control method according to an example of the present disclosure; and

FIG. 7 illustrates a computing system about an autonomous driving control apparatus or an autonomous driving control method according to an example of the present disclosure.

With regard to description of drawings, the same or similar denotations may be used for the same or similar components.

### DETAILED DESCRIPTION

Hereinafter, some examples of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing the components of the example according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

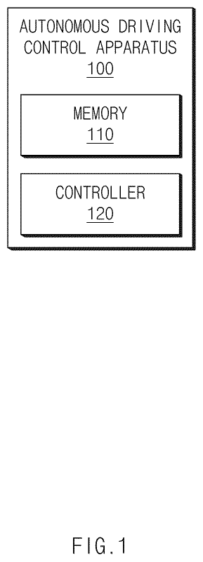

Hereinafter, examples of the present disclosure will be described in detail with reference to FIGS. 1 to 7.

FIG. 1 is a block diagram illustrating components of an autonomous driving control apparatus according to an example of the present disclosure.

According to an example, an autonomous driving control apparatus 100 may include a memory 110 and a controller 120. The components of the autonomous driving control apparatus 100, which are shown in FIG. 1, are illustrative, and examples of the present disclosure are not limited thereto. For example, the autonomous driving control apparatus 100 may further include components (e.g., at least one of a sensor device, a communication device, an interface, a display, or a notification device, or any combination thereof) which are not shown in FIG. 1.

According to an example, the memory 110 may store a command or data. For example, the memory 110 may store one or more instructions, when executed by the controller 120, causing the autonomous driving control apparatus 100 to perform various operations.

For example, the memory 110 and the controller 120 may be implemented as one chipset. The controller 120 may include at least one of a communication processor or a modem.

For example, the memory 110 may store various pieces of information associated with the autonomous driving control apparatus 100. As an example, the memory 110 may store information about an operation history of the controller 120. As an example, the memory 110 may store information associated with states and/or operations of components (e.g., at least one of an engine control unit (ECU), the sensor device, a driving device, an input device, the notification device, and/or the controller 120, or any combination thereof) of a host vehicle.

For example, the memory 110 may include different types of a plurality of storage devices. For example, the memory 110 may include at least one of memories of a first type (e.g., a random-access memory (RAM), a high bandwidth memory (HBM), or any other memories) and/or storage devices of a second type (e.g., an embedded multi-media card (eMMC), a solid state drive (SSD), a hard disk drive, or any other storage devices), or any combination thereof.

As an example, the memory of the first type (e.g., the RAM) may temporarily store data (e.g., driving data) about an operation of the autonomous driving control apparatus 100 and/or the host vehicle which is a control target of the autonomous driving control apparatus 100. The RAM may include, for example, at least one buffer. The autonomous driving control apparatus 100 may store at least one node divided by dividing pieces of data collected (or identified) while performing autonomous driving control for the host vehicle by a unit time. The memories of the first type may include volatile memory.

As an example, the storage device of the second type (e.g., the eMMC, the SSD, etc.) may include a built-in multimedia card. The storage device of the second type (e.g., a non-volatile storage device) may store, for example, data for a longer time than the RAM. The storage device of the second type may be implemented as, for example, a separate memory chip independent of the RAM.

According to an example, the controller 120 may be operatively coupled with the memory 110. For example, the controller 120 may control an operation of the memory 110.

For example, the controller 120 may collect pieces of data about autonomous driving control of the host vehicle.

As an example, the controller 120 may collect (or obtain) various pieces of data generated (or identified) while performing autonomous driving control for the host vehicle.

As an example, the pieces of data about the autonomous driving control may include driving data associated with driving of the host vehicle. The driving data may include, for example, information about at least one of a driving environment of the host vehicle, a driving speed of the host vehicle, or an event occurring while driving, or any combination thereof.

As an example, the controller 120 may temporarily store at least some of the pieces of collected data in the buffer included in the memory 110, while performing autonomous driving control in a specified driving section (e.g., a highway) for the host vehicle. The pieces of collected data may be generated based on various types of sensing data of the vehicle (e.g., one or more image sensors, one or more cameras, one or more light detection and ranging (LiDAR) devices, one or more sound detecting sensors, one or more smoke detectors, one or more gas detectors, etc.)

As an example, the controller 120 may divide (or separate) the pieces of collected data into at least one node and may store the at least one node in the buffer. The controller 120 may store, for example, the at least one node divided by dividing the pieces of collected data by the unit time in the buffer.

As an example, the at least one node may include at least one of time information, data collected in response to the time information, identification information of a next node, or identification previous node, or any combination thereof. The time information may include a time when data corresponding to the at least one node is generated (or identified). The next node may be, for example, a node corresponding to after the unit time from the node. The previous node may be, for example, a node corresponding to before the unit time from the node.

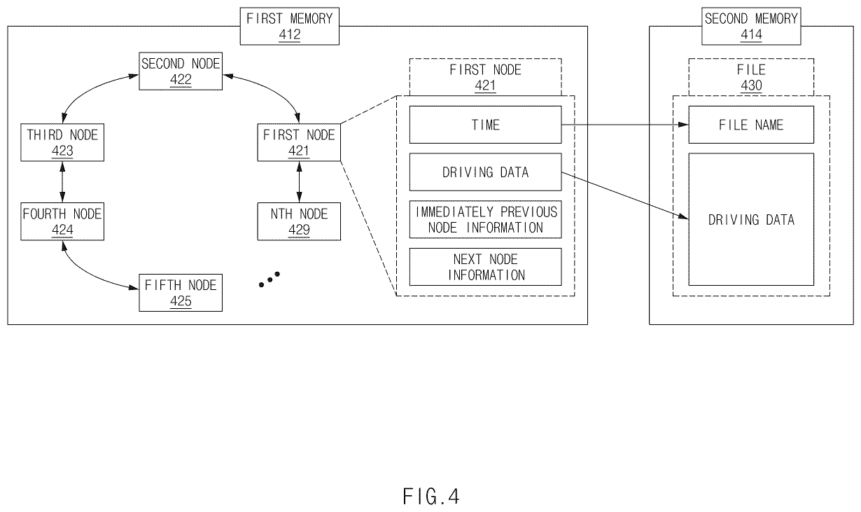

A description of the structure of the node may be further described with respect to FIG. 4, which will be described below.

As an example, the controller 120 may divide the pieces of collected data into the at least one node and may store at least one RAM file system respectively corresponding to the at least one node in the buffer.

As an example, the at least one RAM file system may include at least one of the time information of the at least one node or the data collected in response to the time information, or any combination thereof.

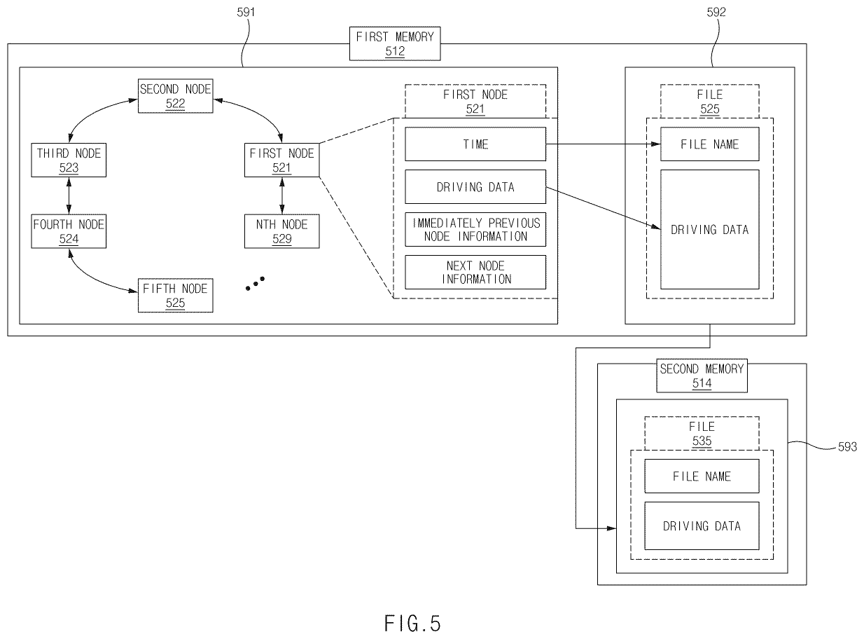

A description of the structure of the RAM file system may be further described with respect to FIG. 5, which will be described below.

For example, based on identifying at least one trigger signal while collecting the pieces of data, the controller 120 may store driving data during a specified duration with respect to a time point when the at least one trigger signal is identified (or a time point when the at least one trigger signal is generated) among the pieces of data in the memory 110. The trigger signal may be generated based on a specified event associated with the vehicle (e.g., one or more events that may occur during autonomous driving of the vehicle).

As an example, the controller 120 may store driving data corresponding to the specified duration among the pieces of data stored in the buffer in a storage device (e.g., an eMMC) included in the memory 110.

As an example, the specified duration may include a duration before a specified time (e.g., 30 seconds) with respect to the time point when the at least one trigger signal is identified and a duration after the specified time with respect to the time point when the at least one trigger signal is identified.

For example, based on identifying that a predefined event occurs while collecting pieces of data, the controller 120 may store specified data corresponding to the predefined event among the pieces of data in the storage device (e.g., the eMMC) without passing through the buffer (or before passing through the buffer).

As an example, the predefined event may include at least one of an event predefined by a developer, an event defined by a setting of a user, or an event defined by laws and regulations, or any combination thereof.

As an example, the predefined event may include activation or deactivation of at least a part of an autonomous driving system of the host vehicle including the autonomous driving control apparatus 100. In other words, when at least some of devices (e.g., the autonomous driving control apparatus 100) included in the autonomous driving system of the host vehicle are activated or deactivated, the autonomous driving control apparatus 100 may identify that the predefined event occurs and may immediately store pieces of data corresponding to the predefined event in the storage device without passing through the buffer (or before passing through the buffer).

As an example, the predefined event may include a situation of at least one of a transition demand (TD), a minimum risk maneuver (MRM), or an emergency maneuver (EM), or any combination thereof. In other words, when the TD situation, the MRM situation, and/or the EM situation occur(s) in the process of performing autonomous driving control for the host vehicle, the autonomous driving control apparatus 100 may identify that the predefined event occurs and may immediately store the pieces of data corresponding to the predefined event in the storage device without passing through the buffer (or before passing through the buffer).

As an example, the predefined event may include a situation in which data of an event data recorder (EDR) is updated. In other words, when it is identified that data is updated in the EDR which is a device which stores some (e.g., accident data) among pieces of data generated in the process of controlling the autonomous driving control for the host vehicle, the autonomous driving control apparatus 100 may identify that the predefined event occurs and may immediately store the pieces of data corresponding to the predefined event in the storage device without passing through the buffer (or before passing through the buffer).

As an example, the predefined event may include a situation in which the performance of the host vehicle deteriorates or a failure in the host vehicle occurs. In other words, when identifying that the driving performance of the host vehicle decreases less than predefined performance or that some of the components of the host vehicle fail, the autonomous driving control apparatus 100 may identify that the predefined event occurs and may immediately store the pieces of data corresponding to the predefined event in the storage device without passing through the buffer (or before passing through the buffer).

For example, when a plurality of trigger signals are continuously generated, the controller 120 may sequentially store pieces of data respectively corresponding to the trigger signals in the storage device.

As an example, the controller 120 may store first driving data during a first duration with respect to a first time point when a first trigger signal among the at least one trigger signal is identified in the buffer.

As an example, the controller 120 may store second driving data during a second duration with respect to a second time point when a second trigger signal among the at least one trigger signal is identified in the buffer. The second time point may be, for example, one time point after the first time point.

As an example, the controller 120 may store the first driving data and the second driving data respectively corresponding to the first duration and the second duration among the pieces of data stored in the buffer in the storage device. Through such a process, the controller 120 may temporarily store the first driving data and the second driving data, which needs to be stored, in the buffer and may copy (or store) the first driving data and the second driving data to (or in) the storage device, thus sequentially storing the pieces of data in the storage device during a relatively longer duration in an order in which they are stored.

As an example, when identifying the at least one trigger signal, the controller 120 may store driving data in which first time information of a first node corresponding to the specified duration among the at least one node is set to a file name in the storage device. In other words, the controller 120 may identify that the first node including the first time information includes data to move from the buffer to the storage device to be stored in the storage device. For example, the controller 120 may identify a specified duration with respect to the time point when the at least one trigger signal is generated and may identify that the first time information includes the specified duration.

For example, the controller 120 may encrypt pieces of data about personal information before storing the pieces of data in the memory 110.

As an example, the controller 120 may encrypt and store at least one of position information of the host vehicle among pieces of driving data or user information, or any combination thereof.

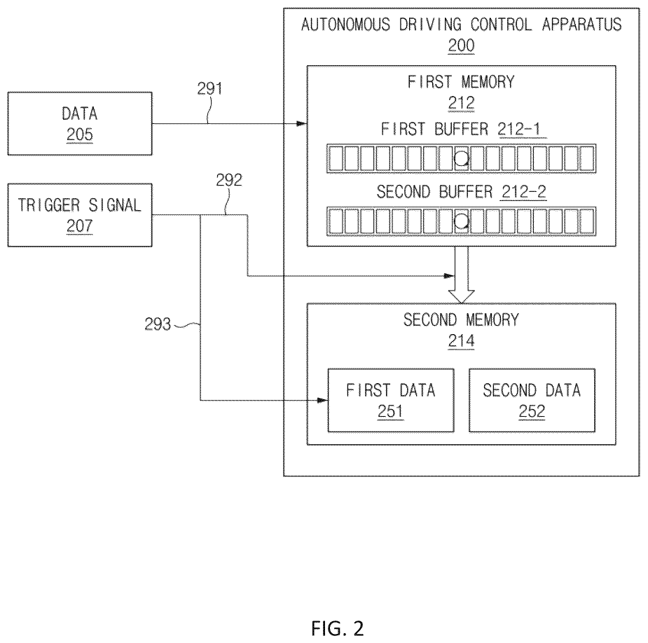

FIG. 2 is a conceptual diagram illustrating components and an operation of an autonomous driving control apparatus according to an example of the present disclosure.

According to an example, an autonomous driving control apparatus 200 (e.g., an autonomous driving control apparatus 100 of FIG. 1) may include a first memory 212 (e.g., a memory, such as a RAM, HBM, etc.) and a second memory 214 (e.g., a storage device, such as an eMMC, an SSD, etc.). For example, the first memory 212 and the second memory 214 may be implemented as one device (e.g., a memory 110 of FIG. 1). For example, the first memory 212 and the second memory 214 may be operatively connected with a controller (e.g., a controller 120 of FIG. 1). For example, the first memory 212 and the second memory 214 may be electrically connected with each other to transmit and receive data.

For example, the first memory 212 may include at least one buffer (212-1 and 212-2).

As an example, the first memory 212 may include a first buffer 212-1 and a second buffer 212-2.

Referring to reference numeral 291, according to an example, the autonomous driving control apparatus 200 may sequentially store data 205 generated (or obtained) while performing autonomous driving control for a host vehicle in the at least one buffer (212-1 and 212-2) included in the first memory 212.

As an example, the second memory 214 may include a storage space for storing data and/or a controller. The second memory 214 may be, for example, an embedded multi-media card (eMMC).

Reference numerals 292 and 293, according to an example, the autonomous driving control apparatus 200 may identify (or detect) a trigger signal 207. If the trigger signal 207 is detected, the autonomous driving control apparatus 200 may store data in the second memory 214 in a different scheme depending on a type of the trigger signal 207.

Referring to reference numeral 292, as an example, if the trigger signal 207 is identified, the autonomous driving control apparatus 200 may store second data 252 corresponding to the trigger signal 207 among pieces of data stored in the at least one buffer (212-1 and 212-2) in the second memory 214.

For example, the autonomous driving control apparatus 200 may move and store the second data 252 corresponding to a specified duration identified based on a time point when the trigger signal 207 is identified (or generated) from the at least one buffer (212-1, 212-2) to the second memory 214.

Referring to reference numeral 293, as an example, if the trigger signal 207 corresponds to a predefined event, the autonomous driving control apparatus 200 may (e.g., immediately) store the first data 251 about the event in the second memory 214 without passing through the first memory 212 (or the at least one buffer (212-1 and 212-2)).

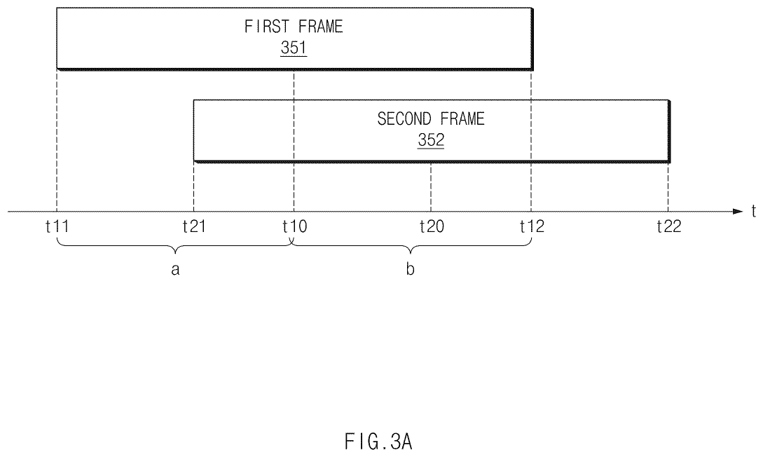

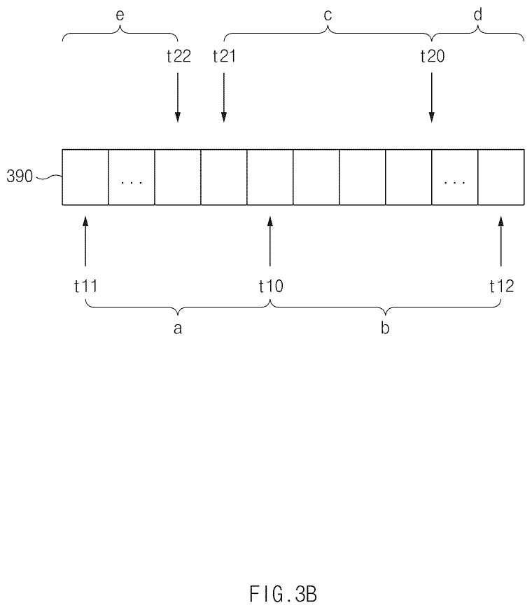

FIG. 3A is a conceptual diagram illustrating data stored by an autonomous driving control apparatus according to an example of the present disclosure.

FIG. 3B is a conceptual diagram illustrating data stored by an autonomous driving control apparatus according to an example of the present disclosure.

Referring to FIG. 3A, according to an example, there may occur a situation in which an autonomous driving control apparatus (e.g., an autonomous driving control apparatus 100 of FIG. 1) should store a plurality of frames 351 and 352 corresponding to data about autonomous driving control in a memory.

For example, the autonomous driving control apparatus may identify that a first trigger signal is generated at a first time point t10. The autonomous driving control apparatus may identify a 1-1st time point t11 which is before time ‘a’ (e.g., 30 seconds) from the first time point t10 and may identify a 1-2nd time point t12 which is after time ‘b’ (e.g., 30 seconds) from the first time point t10. The autonomous driving control apparatus may identify a duration from the 1-1st time point t11 to the 1-2nd time point t12 as a first duration corresponding to the first trigger signal.

For example, the autonomous driving control apparatus may store the first frame 351, which is driving data during the first duration, in the memory, based on the first trigger signal being identified. In this case, the autonomous driving control apparatus may store data corresponding to the first frame 351 among various piece of different data temporarily stored in a buffer in a storage device (e.g., an eMMC) of the memory, which is independent of the buffer.

In such a case, the autonomous driving control apparatus may identify a second trigger signal generated at a second time point t20. The autonomous driving control apparatus may identify a 2-1st time point t21 which is before time ‘a’ (e.g., 30 seconds) from the second time point t20 and may identify a 2-2nd time point t22 which is after time ‘b’ (e.g., 30 seconds) from the second time point t20. The autonomous driving control apparatus may identify a duration from the 2-1st time point t21 to the 2-2nd time point t22 as a second duration corresponding to the second trigger signal.

For example, the autonomous driving control apparatus may store the second frame 352, which is driving data during the second duration, in the memory, based on that the second trigger signal is identified. However, because there is a partially duplicated duration between the second duration corresponding to the second frame 352 and the first duration corresponding to the first frame 351, when the autonomous driving control apparatus is implemented to include a single buffer, there is a limitation to quickly storing the pieces of data. If the autonomous driving control apparatus uses a plurality of buffers to prevent such a situation, as memory usage increases because there is considerable capacity occupied by each of the buffers, an overhead problem may occur. To address such a problem, the autonomous driving control apparatus according to an example of the present disclosure may store data based on an algorithm for FIG. 3B below.

Referring to FIG. 3B, according to an example, the autonomous driving control apparatus may sequentially store pieces of data about autonomous driving control of a host vehicle using one buffer 390. If a plurality of trigger signals are identified, the autonomous driving control apparatus may move (or copy) the pieces of sequentially stored data to the storage device of the memory, which is independent of the buffer 390.

For example, the autonomous driving control apparatus may sequentially store various pieces of data generated (or identified) in the process of performing autonomous driving control for the host vehicle in the buffer 390 over time. For example, when data is stored to a last part (e.g., a part corresponding to t12) of the buffer 390, the autonomous driving control apparatus may reuse an initial part (e.g., a part corresponding to t11) of the buffer 390. If all data are stored to the last part of the buffer 390, the autonomous driving control apparatus may store new data in the initial part of the buffer 390.

For example, the autonomous driving control apparatus may identify that a first trigger signal is generated at a first time point t10. The autonomous driving control apparatus may identify a 1-1st time point t11 which is before time ‘a’ (e.g., 30 seconds) from the first time point t10 and may identify a 1-2nd time point t12 which is after time ‘b’ (e.g., 30 seconds) from the first time point t10. The autonomous driving control apparatus may identify a duration from the 1-1st time point t11 to the 1-2nd time point t12 as a first duration corresponding to the first trigger signal.

For example, the autonomous driving control apparatus may store driving data stored during the first duration among the pieces of data stored in the buffer 390 in the storage device (e.g., the eMMC), based on the first trigger signal being identified. In this case, the autonomous driving control apparatus may store data corresponding to the first duration among various piece of different data temporarily stored in the buffer 390 in the storage device (e.g., the eMMC) of the memory.

In such a case, the autonomous driving control apparatus may identify that a second trigger signal is generated at a second time point t20. The autonomous driving control apparatus may identify a 2-1st time point t21 which is before time ‘c’ (e.g., 30 seconds) from the second time point t20 and may identify a 2-2nd time point t22 which is after time ‘d’ (e.g., 10 seconds) and time ‘e’ (e.g., 20 seconds) elapse from the second time point t20. The autonomous driving control apparatus may identify a duration from the 2-1st time point t21 to the 2-2nd time point t22 as a second duration corresponding to the second trigger signal.

For example, when it elapses by time ‘d’ (e.g., 10 seconds) from the second time point t20, up to the last part of the buffer 390 for storing data may be used. For example, there may be pieces of data stored at the 1-2nd time point t12 in the last part of the buffer 390. In this case, the autonomous driving control apparatus may collect (or store) pieces of data again from the initial part of the buffer 390. For example, there may be pieces of data stored at the 1-1st time point t11 in the initial part of the buffer 390. For example, the autonomous driving control apparatus may sequentially store piece of data identified from a time point when data starts to be stored in the initial part to a time point (e.g., the 2-2nd time point t22) when time ‘e’ elapses from the initial part of the buffer 390.

For example, because of reusing the parts of the buffer 390, according to FIG. 3B, the pieces of data stored at the 2-1st time point t21 and the 2-2nd time point t22 may be present in a previous part of the pieces of data stored at the first time point t10.

For example, the autonomous driving control apparatus may store driving data stored during the second duration among the pieces of data stored in the buffer 390 in the storage device (e.g., the eMMC), based on that the second trigger signal is identified. In this case, the autonomous driving control apparatus may store data corresponding to the second duration among various piece of different data temporarily stored in the buffer 390 in the storage device (e.g., the eMMC) of the memory.

FIG. 4 is an operational conceptual diagram of an autonomous driving control method according to an example of the present disclosure.

According to an example, an autonomous driving control apparatus (e.g., an autonomous driving control apparatus 100 of FIG. 1) may include a first memory 412 (e.g., a first memory 212 of FIG. 2) and a second memory 414 (e.g., a second memory 214 of FIG. 2).

For example, the first memory 412 may store at least one node (421, 422, 423, 424, 425, and 429). The at least one node (421, 422, 423, 424, 425, and 429) may be, for example, a data structure obtained by dividing pieces of data generated (or identified) in a process of performing autonomous driving control for a host vehicle by a unit time.

For example, the at least one node (421, 422, 423, 424, 425, and 429) may include at least one of a time (or time information), data collected in response to the time information, identification information of a next node, or identification information of a previous node, or any combination thereof.

As an example, the time information included in the first node 421 may include a time when driving data included in the first node 421 is generated (or identified).

As an example, the driving data included in the first node 421 may include pieces of data generated (or identified) in a time corresponding to the first node 421.

As an example, immediately previous node information may include identification information of a node (not shown) corresponding to a previous time of the time corresponding to the first node 421.

As an example, the immediately previous node information may include identification information of a node (e.g., the second node 422) corresponding to a next time of the time corresponding to the first node 421.

According to an example, when a trigger signal is identified, the autonomous driving control apparatus may move and store a node corresponding to a specified duration identified based on a time point when the trigger signal is generated among the at least one node (421, 422, 423, 424, 425, and 429) stored in the first memory 412 in the second memory 414.

For example, when the trigger signal is identified, the autonomous driving control apparatus may identify a specified duration based on a time point when the trigger signal is identified (or generated) and may identify the first node 421 including pieces of data corresponding to the specified duration.

For example, the autonomous driving control apparatus may move and store a file 430 including the driving data included in the identified first node 421 in the second memory 414. At this time, a file name of the file 430 may be set to the time corresponding to the first node 421. As a result, the autonomous driving control apparatus may more quickly and accurately store and manage files stored in the second memory 414.

FIG. 5 is an operational conceptual diagram of an autonomous driving control method according to an example of the present disclosure.

According to an example, an autonomous driving control apparatus (e.g., an autonomous driving control apparatus 100 of FIG. 1) may include a first memory 512 (e.g., a first memory 212 of FIG. 2) and a second memory 514 (e.g., a second memory 214 of FIG. 2).

Referring to reference numeral 591, according to an example, the first memory 512 may store at least one node (521, 522, 523, 524, 525, and 529). The at least one node (521, 522, 523, 524, 525, and 529) may be, for example, a data structure obtained by dividing pieces of data generated (or identified) in a process of performing autonomous driving control for a host vehicle by a unit time.

For example, the at least one node (521, 522, 523, 524, 525, and 529) may include at least one of a time (or time information), data collected in response to the time information, identification information of a next node, or identification information of a previous node, or any combination thereof.

As an example, the time information included in the first node 521 may include a time when driving data included in the first node 521 is generated (or identified).

As an example, the driving data included in the first node 521 may include pieces of data generated (or identified) in a time corresponding to the first node 521.

As an example, immediately previous node information may include identification information of a node (not shown) corresponding to a previous time of the time corresponding to the first node 521.

As an example, the immediately previous node information may include identification information of a node (e.g., the second node 522) corresponding to a next time of the time corresponding to the first node 521.

Referring to reference numeral 592, according to an example, the autonomous driving control apparatus may generate and store a RAM file system corresponding to each of the at least one node (521, 522, 523, 524, 525, and 529) (e.g., the file 525 corresponding to the first node 521) in the first memory 512 based on the time and the driving data of each of the at least one node (521, 522, 523, 524, 525, and 529). For example, the autonomous driving control apparatus may store the file 525 (e.g., the RAM file system) including the driving data included in the first node 521 in the first memory 512. At this time, a file name of the file 525 may be set to the time corresponding to the first node 521.

For example, if a trigger signal is identified, the autonomous driving control apparatus may identify a node corresponding to a specified duration identified based on a time point when the trigger signal is generated among the at least one node (521, 522, 523, 524, 525, and 529) stored in the first memory 512 and may copy and store a file corresponding to the identified node in the second memory 514.

For example, if the trigger signal is identified, the autonomous driving control apparatus may identify the specified duration based on the time point when the trigger signal is identified (or generated) and may identify the first node 521 including pieces of data corresponding to the specified duration.

Referring to reference numeral 593, according to an example, the autonomous driving control apparatus may copy the file 525 corresponding to the identified first node 521 to the second memory 514 and may store the copied file 525. The copied file 535 may include substantially the same data as the file 525 stored in the first memory, 512. As a result, the autonomous driving control apparatus may previously generate and store data of a file structure corresponding to nodes in the first memory 512 and may immediately copy a corresponding file to the second memory 514 when identifying a trigger signal corresponding to the corresponding file, thus quickly storing and managing a RAM file system while minimizing controller activation of the second memory 514.

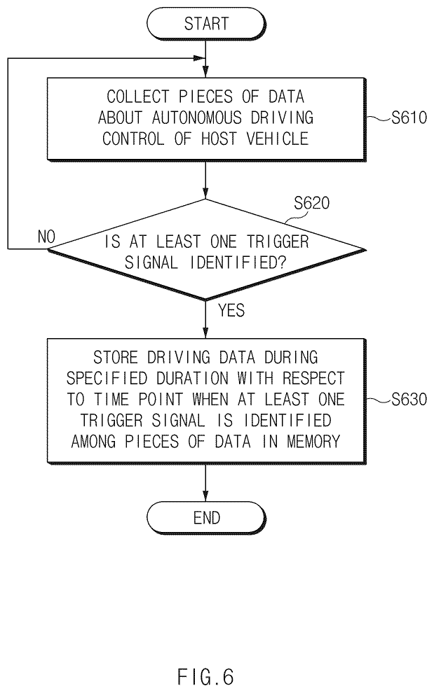

FIG. 6 is a flowchart of an autonomous driving control method according to an example of the present disclosure.

According to an example, an autonomous driving control apparatus (e.g., an autonomous driving control apparatus 100 of FIG. 1) may perform operations disclosed in FIG. 6. For example, at least some of components (e.g., a memory 110 and a controller 120 of FIG. 1) included in the autonomous driving control apparatus may be configured to perform the operations of FIG. 6.

Operations in S610 to S630 in an example below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 6, may be briefly described or omitted.

According to an example, in S610, the autonomous driving control apparatus may collect pieces of data about autonomous driving control of a host vehicle.

According to an example, in S620, the autonomous driving control apparatus may determine whether at least one trigger signal is identified.

For example, when the at least trigger signal is identified (e.g., S620—YES), the autonomous driving control apparatus may perform S630.

For example, when the at least trigger signal is not identified (e.g., S620—NO), the autonomous driving control apparatus may repeatedly perform S610.

According to an example, in S630, the autonomous driving control apparatus may store driving data during a specified duration with respect to a time point when the at least one trigger signal is identified among pieces of data in a memory.

According to an aspect of the present disclosure, the autonomous driving control apparatus may include a memory storing at least one instruction and a controller operatively connected with the memory. For example, the at least one instruction may be configured to, when executed by the controller, cause the autonomous driving control apparatus to collect pieces of data about autonomous driving control of a host vehicle and store driving data during a specified duration with respect to a time point when at least one trigger signal is identified among the pieces of data in the memory, when identifying the at least one trigger signal while collecting the pieces of data.

According to an example, the at least one instruction may be configured to, when executed by the controller, cause the autonomous driving control apparatus to store at least some of the pieces of collected data in a buffer included in the memory, while performing the autonomous driving control in a specified driving section for the host vehicle.

According to an example, the at least one instruction may be configured to, when executed by the controller, cause the autonomous driving control apparatus to store the driving data corresponding to the specified duration among the pieces of data stored in the buffer in a storage device included in the memory.

According to an example, the storage device may include an embedded multi-media card (eMMC).

According to an example, the at least one instruction may be configured to, when executed by the controller, cause the autonomous driving control apparatus to store specified data corresponding to a predefined event among the piece of data in the storage device, when identifying that the predefined event occurs while collecting the piece of data.

According to an example, the at least one instruction may be configured to, when executed by the controller, cause the autonomous driving control apparatus to store first driving data during a first duration with respect to a first time point when a first trigger signal among the at least one trigger signal is identified in the buffer, store second driving data during a second duration with respect to a second time point when a second trigger signal among the at least one trigger signal is identified, the second time point being subsequent to the first time point, in the buffer, and store the first driving data and the second driving data respectively corresponding to the first duration and the second duration among the pieces of data stored in the buffer in the storage device.

According to an example, the at least one instruction may be configured to, when executed by the controller, cause the autonomous driving control apparatus to divide the piece of collected data into at least one node and store the at least one node in the buffer and store the driving data in which first time information of a first node corresponding to the specified duration among the at least one node is set to a file name in the storage device, when identifying the at least one trigger signal. For example, the at least one node may include at least one of time information, data collected in response to the time information, identification information of a next node, or identification information of a previous node, or any combination thereof.

According to an example, the at least one instruction may be configured to, when executed by the controller, cause the autonomous driving control apparatus to divide the pieces of collected data into the at least one node and store at least one RAM file system respectively corresponding to the at least one node in the buffer and copy a specified RAM file system corresponding to the specified duration among the at least one RAM file system to the storage device, when identifying the at least one trigger signal. For example, the at least one RAM file system may include at least one of the time information of the at least node or the data collected in response to the time information, or any combination thereof.

According to an example, the predefined event may include at least one of activation or deactivation of at least a part of an autonomous driving system of the host vehicle including the autonomous driving control apparatus, occurrence of a situation of at least one of a transition demand (TD), a minimum risk maneuver (MRM), or an emergency maneuver (EM), or any combination thereof, an update of data of an event data recorder (EDR), or occurrence of deterioration in performance of the host vehicle or occurrence of a failure in the host vehicle, or any combination thereof.

According to an example, the at least one instruction may be configured to, when executed by the controller, cause the autonomous driving control apparatus to encrypt and store at least one of position information of the host vehicle among the driving data or user information, or any combination thereof in the memory.

According to another aspect of the present disclosure, an autonomous driving control method may include collecting, by a controller, pieces of data about autonomous driving control of a host vehicle and storing, by the controller, driving data during a specified duration with respect to a time point when at least one trigger signal is identified among the pieces of data in a memory, when identifying the at least one trigger signal while collecting the pieces of data.

According to an example, the autonomous driving control method may further include storing, by the controller, at least some of the pieces of collected data in a buffer included in the memory, while performing the autonomous driving control in a specified driving section for the host vehicle.

According to an example, the autonomous driving control method may further include storing, by the controller, the driving data corresponding to the specified duration among the pieces of data stored in the buffer in a storage device included in the memory.

According to an example, the storage device may include an embedded multi-media card (eMMC).

According to an example, the autonomous driving control method may further include storing, by the controller, specified data corresponding to a predefined event among the piece of data in the storage device, when identifying that the predefined event occurs while collecting the piece of data.

According to an example, the autonomous driving control method may further include storing, by the controller, first driving data during a first duration with respect to a first time point when a first trigger signal among the at least one trigger signal is identified in the buffer, storing, by the controller, second driving data during a second duration with respect to a second time point when a second trigger signal among the at least one trigger signal is identified, the second time point being subsequent to the first time point, in the buffer, and storing the first driving data and the second driving data respectively corresponding to the first duration and the second duration among the pieces of data stored in the buffer in the storage device.

According to an example, the autonomous driving control method may further include dividing, by the controller, the piece of collected data into at least one node and storing, by the controller, the at least one node in the buffer and storing, by the controller, the driving data in which first time information of a first node corresponding to the specified duration among the at least one node is set to a file name in the storage device, when identifying the at least one trigger signal. For example, the at least one node may include at least one of time information, data collected in response to the time information, identification information of a next node, or identification information of a previous node, or any combination thereof.

According to an example, the autonomous driving control method may further include dividing, by the controller, the pieces of collected data into the at least one node and storing, by the controller, at least one RAM file system respectively corresponding to the at least one node in the buffer and copying, by the controller, a specified RAM file system corresponding to the specified duration among the at least one RAM file system to the storage device, when identifying the at least one trigger signal. For example, the at least one RAM file system may include at least one of the time information of the at least node or the data collected in response to the time information, or any combination thereof.

According to an example, the predefined event may include at least one of activation or deactivation of at least a part of an autonomous driving system of the host vehicle including an autonomous driving control apparatus, occurrence of a situation of at least one of a transition demand (TD), a minimum risk maneuver (MRM), or an emergency maneuver (EM), or any combination thereof, an update of data of an event data recorder (EDR), or occurrence of deterioration in performance of the host vehicle or occurrence of a failure in the host vehicle, or any combination thereof.

According to an example, the autonomous driving control method may further include encrypting and storing, by the controller, at least one of position information of the host vehicle among the driving data or user information, or any combination thereof in the memory.

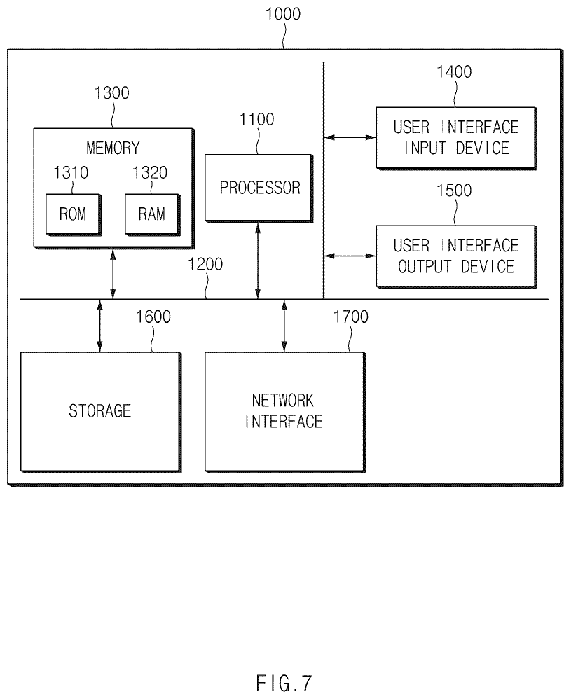

FIG. 7 illustrates a computing system about an autonomous driving control apparatus or an autonomous driving control method according to an example of the present disclosure.

Referring to FIG. 7, a computing system 1000 about the autonomous driving control apparatus or the autonomous driving control method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

A description will be given of effects of the autonomous driving control apparatus and the method thereof according to an example of the present disclosure.

The autonomous driving control apparatus according to examples of the present disclosure may adaptively perform an operation of storing and managing data although there is a limitation to the number (or capacity) of buffers included in a memory when a trigger signal about storing data is continuously generated, in the process of storing data about the driving of a host vehicle in the memory.

The autonomous driving control apparatus according to examples of the present disclosure may sequentially store pieces of data in the memory with regard to priorities for the pieces of data when storing the pieces of data.

The autonomous driving control apparatus according to examples of the present disclosure may identify a time point when the trigger signal is generated and may store data during a specified duration including a specified time (e.g., 30 seconds) before the identified time point and a specified time (e.g., 30 seconds) after the identified time point in the memory, thus efficiently storing data at the same as complying with laws and regulations.

The autonomous driving control apparatus according to examples of the present disclosure may temporarily store a node provided by dividing data by a unit time in a buffer (or a RAM) and may quickly identify at least one node which should be stored in a storage device (e.g., an embedded multi-media Card (eMMC)) based on time information included in the node, thus storing pieces of driving data included in the identified at least one node in the storage device. For example, the autonomous driving control apparatus may store a file including pieces of driving data in the storage device and may set time information corresponding to the identified at least one node to a file name of the file, thus quickly and accurately identifying time information of the pieces of driving data later.

The autonomous driving control apparatus according to examples of the present disclosure may quickly copy at least some data associated with a trigger signal among the pieces of data temporarily stored in the buffer to the storage device (e.g., the embedded multi-media card (eMMC)).

In addition, various effects ascertained directly or indirectly through the present disclosure may be provided.

Hereinabove, although the present disclosure has been described with reference to exemplary examples and the accompanying drawings, the present disclosure is not limited thereto, but may be variously modified and altered by those skilled in the art to which the present disclosure pertains without departing from the spirit and scope of the present disclosure claimed in the following claims.

Therefore, examples of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An autonomous driving control apparatus comprising:
memory storing at least one instruction; and
a controller operatively coupled to the memory,
wherein the at least one instruction is configured to, when executed by the controller, cause the autonomous driving control apparatus to:
control, by using at least one sensor of a vehicle, autonomous driving of the vehicle;
collect, during an operation of the autonomous driving of the vehicle, pieces of data about autonomous driving control of the vehicle;
store, in at least one buffer of a first memory of a first type, the pieces of data about autonomous driving control of the vehicle, wherein the pieces of data about autonomous driving control of the vehicle is configured to be stored in a first format;
convert at least a portion of the pieces of data about autonomous driving control of the vehicle to a second format for storing in a storage of a second type;
receive a triggering signal; and
based on a reception time of the triggering signal, store, in the storage of the second type, driving data corresponding to a specified duration, wherein the specified duration is determined based on the reception time of the triggering signal, and wherein the driving data corresponding to the specified duration is converted, from the first format to the second format, based on a portion of the pieces of data about autonomous driving control of the vehicle.

2. The autonomous driving control apparatus of claim 1, wherein the at least one instruction is configured to, when executed by the controller, cause the autonomous driving control apparatus to:
store the pieces of data about autonomous driving control of the vehicle by storing a first portion of the pieces of collected data in a first buffer of the at least one buffer, while performing the autonomous driving control in a specified driving section for the vehicle, wherein the first portion of the pieces of collected data is associated with the reception time of the triggering signal.

3. The autonomous driving control apparatus of claim 2, wherein the at least one instruction is configured to, when executed by the controller, cause the autonomous driving control apparatus to:
store the pieces of data about autonomous driving control of the vehicle by storing a second portion of the pieces of collected data in the first buffer, wherein the second portion of the pieces of collected data is associated with a reception time of a second triggering signal, wherein the second portion of the pieces of collected data is stored, using a pointer associated with the reception time of the second triggering signal, in the first buffer, and
wherein the first portion of the pieces of collected data is stored, using a pointer associated with the reception time of the triggering signal, in the first buffer.

4. The autonomous driving control apparatus of claim 1, wherein the storage of the second type comprises at least one of:
an embedded multi-media card (eMMC); or
a solid state drive (SSD).

5. The autonomous driving control apparatus of claim 1, wherein the at least one instruction is configured to, when executed by the controller, cause the autonomous driving control apparatus to:
store specified data corresponding to a predefined event among the pieces of data, in the storage of the second type, based on a determination that the predefined event occurs while collecting the pieces of data.

6. The autonomous driving control apparatus of claim 1, wherein the at least one instruction is configured to, when executed by the controller, cause the autonomous driving control apparatus to:
store, in the at least one buffer, first driving data corresponding to a first duration associated with the reception time of the triggering signal;
store, in the at least one buffer, second driving data corresponding to a second duration associated with a second reception time of a second triggering signal, the second reception time being subsequent to the reception time; and
store, in the storage of the second type, the first driving data and the second driving data respectively corresponding to the first duration and the second duration among the pieces of data stored in the at least one buffer.

7. The autonomous driving control apparatus of claim 1, wherein the at least one instruction is configured to, when executed by the controller, cause the autonomous driving control apparatus to:
divide the pieces of collected data into at least one node and store the at least one node in the at least one buffer; and
store at least one piece of the driving data in which first time information of a first node corresponding to the specified duration among the at least one node is set to a file name in the storage of the second type, and
wherein the at least one node comprises at least one of time information, data collected in response to the time information, identification information of a next node, or identification information of a previous node, or any combination thereof.

8. The autonomous driving control apparatus of claim 7, wherein the at least one instruction is configured to, when executed by the controller, cause the autonomous driving control apparatus to:
store, in the at least one buffer, at least one random access memory (RAM) file system respectively corresponding to the at least one node; and
copy a specified RAM file system corresponding to the specified duration among the at least one RAM file system to the storage of the second type, based on the triggering signal, and
wherein the at least one RAM file system comprises at least one of the time information of the at least one node or the data collected in response to the time information, or any combination thereof.

9. The autonomous driving control apparatus of claim 5, wherein the predefined event comprises at least one of:
activation or deactivation of at least a part of an autonomous driving system of the vehicle that comprises the autonomous driving control apparatus;
occurrence of an event of at least one of a transition demand (TD), a minimum risk maneuver (MRM), or an emergency maneuver (EM), or any combination thereof;
an update of data of an event data recorder (EDR);
occurrence of deterioration in performance of the vehicle or occurrence of a failure in the vehicle;
or any combination thereof.

10. The autonomous driving control apparatus of claim 1, wherein the at least one instruction is configured to, when executed by the controller, cause the autonomous driving control apparatus to:
encrypt and store at least one of position information of the vehicle among the driving data or user information, or any combination thereof.

11. An autonomous driving control method, comprising:
controlling, by using at least one sensor of a vehicle, autonomous driving of the vehicle;
collecting, by a controller and during an operation of the autonomous driving of the vehicle, pieces of data about autonomous driving control of the vehicle;
storing, in at least one buffer of a first memory of a first type, the pieces of data about autonomous driving control of the vehicle, wherein the pieces of data about autonomous driving control of the vehicle is configured to be stored in a first format;
converting, by the controller, at least a portion of the pieces of data about autonomous driving control of the vehicle to a second format for storing in a storage of a second type;
receiving, by the controller, a triggering signal; and
based on a reception time of the triggering signal, storing, by the controller and in the storage of the second type, driving data corresponding to a specified duration, wherein the specified duration is determined based on the reception time of the triggering signal, and wherein the driving data corresponding to the specified duration is converted, from the first format to the second format, based on a portion of the pieces of data about autonomous driving control of the vehicle.

12. The autonomous driving control method of claim 11, further comprising:
storing the pieces of data about autonomous driving control of the vehicle by storing, by the controller, a first portion of the pieces of collected data in a first buffer of the at least one buffer, while performing the autonomous driving control in a specified driving section for the vehicle, wherein the first portion of the pieces of collected data is associated with the reception time of the triggering signal.

13. The autonomous driving control method of claim 12, further comprising:
storing, by the controller, the pieces of data about autonomous driving control of the vehicle by storing a second portion of the pieces of collected data in the first buffer, wherein the second portion of the pieces of collected data is associated with a reception time of a second triggering signal, wherein the second portion of the pieces of collected data is stored, using a pointer associated with the reception time of the second triggering signal, in the first buffer, and
wherein the first portion of the pieces of collected data is stored, using a pointer associated with the reception time of the triggering signal, in the first buffer.

14. The autonomous driving control method of claim 11, wherein the storage of the second type comprises at least one of:
an embedded multi-media card (eMMC); or
a solid state drive (SSD).

15. The autonomous driving control method of claim 11, further comprising:
storing, by the controller, specified data corresponding to a predefined event among the pieces of data, in the storage of the second type, based on a determination that the predefined event occurs while collecting the pieces of data.

16. The autonomous driving control method of claim 11, further comprising:
storing, by the controller and in the at least one buffer, first driving data corresponding to a first duration associated with the reception time of the triggering signal;
storing, by the controller and in the at least one buffer, second driving data corresponding to a second duration associated with a second reception time of a second triggering signal, the second reception time being subsequent to the reception time; and
storing, in the storage of the second type, the first driving data and the second driving data respectively corresponding to the first duration and the second duration among the pieces of data stored in the at least one buffer.

17. The autonomous driving control method of claim 11, further comprising:
dividing, by the controller, the pieces of collected data into at least one node and storing, by the controller, the at least one node in the at least one buffer; and
storing, by the controller, at least one piece of the driving data in which first time information of a first node corresponding to the specified duration among the at least one node is set to a file name in the storage of the second type, and
wherein the at least one node comprises at least one of time information, data collected in response to the time information, identification information of a next node, or identification information of a previous node, or any combination thereof.

18. The autonomous driving control method of claim 17, further comprising:
storing, by the controller and in the at least one buffer, at least one random access memory (RAM) file system respectively corresponding to the at least one node; and
copying, by the controller, a specified RAM file system corresponding to the specified duration among the at least one RAM file system to the storage of the second type, based on the triggering signal, and
wherein the at least one RAM file system comprises at least one of the time information of the at least one node or the data collected in response to the time information, or any combination thereof.

19. The autonomous driving control method of claim 15, wherein the predefined event comprises at least one of:
activation or deactivation of at least a part of an autonomous driving system of the vehicle that comprises an autonomous driving control apparatus;
occurrence of an event of at least one of a transition demand (TD), a minimum risk maneuver (MRM), or an emergency maneuver (EM), or any combination thereof;
an update of data of an event data recorder (EDR);
occurrence of deterioration in performance of the vehicle or occurrence of a failure in the vehicle;
or any combination thereof.

20. The autonomous driving control method of claim 11, further comprising:
encrypting and storing, by the controller, at least one of position information of the vehicle among the driving data or user information, or any combination thereof.
